(19) United States
(12) Patent Application Publication
(10) Pub. No.: US 2006/0170988 A1
(43) Pub. Date: Aug. 3, 2006

(54) Film carrier

(75) Inventors: Kenichi Kato, Kanagawa (JP); Hisatsugu Torii, Kanagawa (JP); Yoshiyuki Yamaguchi, Kanagawa (JP); Takashi Utsumi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/293,294

(22) Filed: Dec. 5, 2005

(30) Foreign Application Priority Data
Dec. 3, 2004 (JP) 2004-351083
Dec. 3, 2004 (JP) 2004-351084
Dec. 3, 2004 (JP) 2004-351085

(51) Int. Cl. H04N 1/04

(52) U.S. Cl. 358/496

(57) ABSTRACT

A film carrier conveys photographic film along a conveyance path to an image reading position, in order to read an image by irradiating with light an image frame recorded in the photographic film. The film carrier includes: a reference plate for setting the photographic film at a reference position; a pair of mask members that press and release both conveyance-direction edge portions of the surface of the photographic film conveyed to the image reading position; mask member moving unit that causes the pair of mask members to move along the conveyance direction in accordance with the size of the image frame; a pair of pressure members that nip and release the photographic film; and pressure member moving unit that causes the pair of pressure members to move toward and away from the reference plate.

### CROSS-REFERENCE TO RELATED APPLICATIONS

This application claims priority under 35 USC 119 from Japanese Patent Applications Nos. 2004-351083, 2004-351084 and 2004-351085, the disclosures of which are incorporated by reference herein.

### BACKGROUND OF THE INVENTION

1. Field of the Invention

The present invention relates to a film carrier that conveys photographic film along a conveyance path to an image reading position in order to read an image by irradiating, with light, an image frame recorded in the photographic film.

2. Description of the Related Art

Among scanners for photographic film (digital scanners), there are scanners where a film carrier is detachably loaded in the body portion of the scanner, photographic film is conveyed to a predetermined image reading position along a conveyance path disposed in the film carrier, and frame images recorded in the photographic film are read by a CCD area sensor at the image reading position. In such scanners, light (film-transmitted light) emitted from a light source and transmitted through the photographic film is imaged on a light-receiving surface of the CCD area sensor by a lens unit, and the film-transmitted light retaining the image is converted to an electrical image signal by the CCD area sensor. For this reason, when the image is read with respect to the photographic film, it is necessary to precisely maintain, at a constant position with respect to the lens unit along the light irradiation direction (light axis direction), the photographic film conveyed to the image reading position.

Clamping means have been proposed which, when the image frame of photographic film (a film strip) is to be flattened with respect to a base plate disposed at the image reading position, flattens the image frame by causing a clamping force to act in the vertical direction and the width direction along both edges of the image frame in the film longitudinal direction and causing a clamping force to act in the vertical direction along both edges of the image frame in the film width direction (e.g., see Japanese Patent Application Publication (JP-A) No. 7-199366). It has also been proposed that in the clamping of the image frame using the clamping means, in relation to the timing at which the clamping forces act, the clamping forces may be caused to act such that the clamping element in the film width direction contacts the photographic film later than the clamping element in the film longitudinal direction.

There are film carriers disposed with variable masks in order to accommodate trimming print ranges and various types of frame sizes, such as full-size frames, half-size frames, and panorama-size frames recorded in 135 mm photographic film. A film carrier has been proposed where, in order to ensure that the flatness of the photographic film is not compromised by the variable masks, a pair of feeding direction-variable masks that move in mutually opposite directions in the feeding direction (conveyance direction) of the photographic film and a pair of width direction-variable masks that move in mutually opposite directions in the width direction of the photographic film are disposed on the same plane in which they slidingly contact the photographic film (e.g., see JP-A No. 7-5590).

Photographic film curls in response to humidity and the environment in which the photographic film is left, but the clamping means disclosed in JP-A No. 7-199366, which flatten the frame image by causing clamping forces to act on the photographic film not only in the vertical direction but also in the width direction, are useful because they eliminate the affects of any curl that photographic film has and suppress deterioration in the precision of the image reading. However, in a flat conveyance path, the curl usually becomes a gutter-shaped curl having a curvature in the film width direction. Thus, as described in JP-A No. 7-199366, when clamping forces are caused to act by causing the clamping element of the clamping means in the width direction to contact the photographic film at the same time or later than the clamping element in the longitudinal direction, there is the potential for the curl to be insufficiently suppressed by the clamping element in the longitudinal direction in the case of photographic film having a large gutter-shaped curl (a curl whose curvature is large).

Also, in devices that press medium-format film with masks and read an image, it is difficult to maintain the image portion flat because the film width size is large, and particularly in a dry environment, sometimes the focal point of the image becomes blurry because the film curls to a great extent. Also, in film where the percentage occupied by the area outside the image regions is extremely small with respect to the entire film width, as in medium-format film, there is the potential for the film to fall through the opening portion if the open area is enlarged in order to secure the image plane opening. For this reason, as shown in FIG. 7, it is necessary to close off an opening portion 102 using a transparent member 100 comprising a glass plate, for example. However, in this case, when curled photographic film F is pressed with a mask 104, it becomes difficult for the air between the photographic film F and the transparent member 100 to escape, and there is the problem that the flatness of the film can no longer be ensured.

Also, the image frame size of the film to which the device disclosed in JP-A No. 7-199366 is directed is constant, and the device cannot accommodate changes in formats where the film width is the same but the size in the conveyance direction of the film is different, such as full- and half-size 135 mm film, and 6×4.5, 6×6, 6×7, 6×8, and 6×9 medium-format film.

In JP-A No. 7-5590, changes in the image frame size in the conveyance direction of the film, such as described above, can be accommodated by feeding direction-variable masks, but because the feeding direction-variable masks slidingly contact the photographic film, there is the potential for the photographic film to be damaged by the operation of the variable masks. Also, in one-frame film conveyance, when the curl in the photographic film is large, there is the potential for the masks to become caught on the photographic film in the operation of the feeding direction-variable masks and for the film to become unable to be conveyed.

### SUMMARY OF THE INVENTION

In view of these circumstances, the present invention provides a film carrier that can accommodate changes in the sizes of the image frames in the conveyance direction without damaging the photographic film, can reliably suppress curls even in photographic film having a large gutter-shaped curl, and can improve the flatness of the photographic film. The present invention also provides a film carrier that can reliably suppress curls even in photographic film whose film width size is large, as in medium-format film, and can improve the flatness of the photographic film.

A first aspect of the invention provides a film carrier that conveys photographic film along a conveyance path to an image reading position, in order to read an image by irradiating with light an image frame recorded in the photographic film, the film carrier comprising: a reference plate that is disposed at the image reading position, is contacted by the undersurface of the photographic film conveyed to the image reading position, and sets the photographic film at a reference position along the light irradiation direction; a pair of mask members that are positioned upstream and downstream of the image reading position in the conveyance direction of the photographic film, are configured to move toward and away from the reference plate, with at least one of the pair of mask members being movable along the conveyance direction, and that press and release both conveyance-direction edge portions of the surface of the photographic film conveyed to the image reading position; mask member moving unit that causes the pair of mask members to move toward and away from the reference plate and causes at least one of the pair of mask members to move along the conveyance direction in accordance with the size of the image frame; a pair of pressure members that are positioned at both sides of the image reading position in the width direction of the photographic film, are configured to move toward and away from the reference plate, press both width-direction edge portions of the surface of the photographic film conveyed to the image reading position to nip the photographic film between the reference plate and the pair of pressure members, and release the photographic film such that the photographic film is no longer nipped between the pair of pressure members and the reference plate; and pressure member moving unit that causes the pair of pressure members to move toward and away from the reference plate, wherein with respect to the photographic film conveyed to the image reading position, the pair of pressure members is caused to press the photographic film after the photographic film is pressed by the pair of mask members.

A second aspect of the invention provides a film carrier that conveys photographic film along a conveyance path to an image reading position, in order to read an image by irradiating with light an image frame recorded in the photographic film, the film carrier comprising: a reference plate that is disposed at the image reading position, is contacted by the undersurface of the photographic film conveyed to the image reading position, and sets the photographic film at a reference position along the light irradiation direction; four press members that are positioned upstream and downstream of the image reading position in the conveyance direction of the photographic film and at both sides of the image reading position in the width direction of the photographic film, are configured to move toward and away from the reference plate, and press and release both conveyance-direction edge portions and both width-direction edge portions of the surface of the photographic film conveyed to the image reading position; moving unit that causes the four press members to move toward and away from the reference plate; and an opening portion that is disposed in the reference plate and allows air to escape from a space formed between the photographic film and the reference plate when the photographic film is pressed by the four press members.

A third aspect of the invention provides a film carrier that conveys photographic film along a conveyance path to an image reading position, in order to read an image by irradiating with light an image frame recorded in the photographic film, the film carrier comprising: a reference plate that is disposed at the image reading position, is contacted by the undersurface of the photographic film conveyed to the image reading position, and sets the photographic film at a reference position along the light irradiation direction; a pair of press members that are positioned upstream and downstream of the image reading position in the conveyance direction of the photographic film, are configured to move toward and away from the reference plate, and press and release both conveyance-direction edge portions of the surface of the photographic film conveyed to the image reading position; moving unit that causes the pair of press members to move toward and away from the reference plate; a pair of conveyance units that are disposed at both sides of the image reading position in the width direction of the photographic film, pressingly contact both width-direction edge portions of the surface of the photographic film, and convey the photographic film to the image reading position; and an opening portion that is disposed in the reference plate and allows air to escape from a space formed between the photographic film and the reference plate when the photographic film is pressed by the pair of press members.

A fourth aspect of the invention provides a film carrier that conveys photographic film along a conveyance path to an image reading position, in order to read an image by irradiating with light an image frame recorded in the photographic film, the film carrier comprising: a reference plate that is disposed at the image reading position, is contacted by the undersurface of the photographic film conveyed to the image reading position, and sets the photographic film at a reference position along the light irradiation direction; a pair of press members that are positioned upstream and downstream of the image reading position in the conveyance direction of the photographic film, are configured to move toward and away from the reference plate, and press and release both conveyance-direction edge portions of the surface of the photographic film conveyed to the image reading position; a pair of conveyance units that are positioned at a predetermined interval with respect to the reference plate at both sides of the image reading position in the width direction of the photographic film, pressingly contact both width-direction edge portions of the surface of the photographic film, and convey the photographic film to the image reading position; and moving unit(s) that causes the pair of press members to move toward and away from the reference plate and causes the pair of conveyance units to move in the width direction.

Other aspects, features and advantages of the present invention will become apparent from the following description taken in conjunction with the accompanying drawings.

### BRIEF DESCRIPTION OF THE DRAWINGS

Preferred embodiments of the present invention will be described in detail based on the following figures, in which:

FIG. 1 is a perspective view showing a film carrier pertaining to an embodiment of the invention;

FIG. 2 is a perspective view showing the film carrier of FIG. 1 without masks, mask retention members, and a drive mechanism;

FIG. 3 is a perspective view showing relevant portions of the film carrier pertaining to an embodiment of the invention seen from the upstream side of a film conveyance path;

FIG. 4A is a diagram describing the operation of suppressing a curl in photographic film with the film carrier pertaining to an embodiment of the invention, and illustrates a state just after photographic film having a gutter-shaped curl has been conveyed to an image reading section;

FIG. 4B is a diagram describing the operation of suppressing a curl in photographic film with the film carrier pertaining to an embodiment of the invention, and illustrates a state where the curl in the photographic film is being suppressed;

FIG. 5A is a diagram describing the operation of suppressing a curl in photographic film with a film carrier pertaining to a second embodiment of the invention, and illustrates a state just after photographic film having a gutter-shaped curl has been conveyed to the image reading section;

FIG. 5B is a diagram describing the operation of suppressing a curl in photographic film with the film carrier pertaining to the second embodiment of the invention, and illustrates a state where the curl in the photographic film is being suppressed;

FIGS. 6A and 6B are longitudinal cross-sectional views, along a film width direction in the image reading section, showing the structure of a base plate pertaining to a modification of the invention;

FIG. 7 is a diagram describing the operation of suppressing a curl in photographic film by a conventional film carrier;

FIG. 8 is a perspective view showing a pair of conveyance units pertaining to a third embodiment of the invention;

FIG. 9A is a diagram describing the operation of suppressing a curl in photographic film with a film carrier pertaining to the third embodiment of the invention, and illustrates a state just after photographic film having a gutter-shaped curl has been conveyed to the image reading section;

FIG. 9B is a diagram describing the operation of suppressing a curl in photographic film with the film carrier pertaining to the third embodiment of the invention, and illustrates a state where the curl of the photographic film is being suppressed;

FIG. 10A is a one of diagrams describing the size of a curl remaining when photographic film is pressed by different operations, and illustrates a state where the photographic film has been set in the image reading section;

FIG. 10B is a one of diagrams describing the size of a curl remaining when photographic film is pressed by different operations, and illustrates a state where the photographic film has been released after the state shown in FIG 10A;

FIG. 10C is a one of diagrams describing the size of a curl remaining when photographic film is pressed by different operations, and illustrates a state where the photographic film has been pressed after the state shown in FIG 10B;

FIG. 10D is a one of diagrams describing the size of a curl remaining when photographic film is pressed by different operations, and illustrates a state where the photographic film has been pressed without being released after the state shown in FIG. 10A;

FIG. 11 is a schematic configural view showing film conveyance unit in the film carrier pertaining to the third embodiment of the invention; and

FIG. 12 is a schematic side view showing a conveyance roller pair in the film conveyance unit of FIG. 11.

### DETAILED DESCRIPTION OF THE INVENTION

A film carrier according to embodiments of the invention will be described below with reference to the drawings.

### FIRST EMBODIMENT

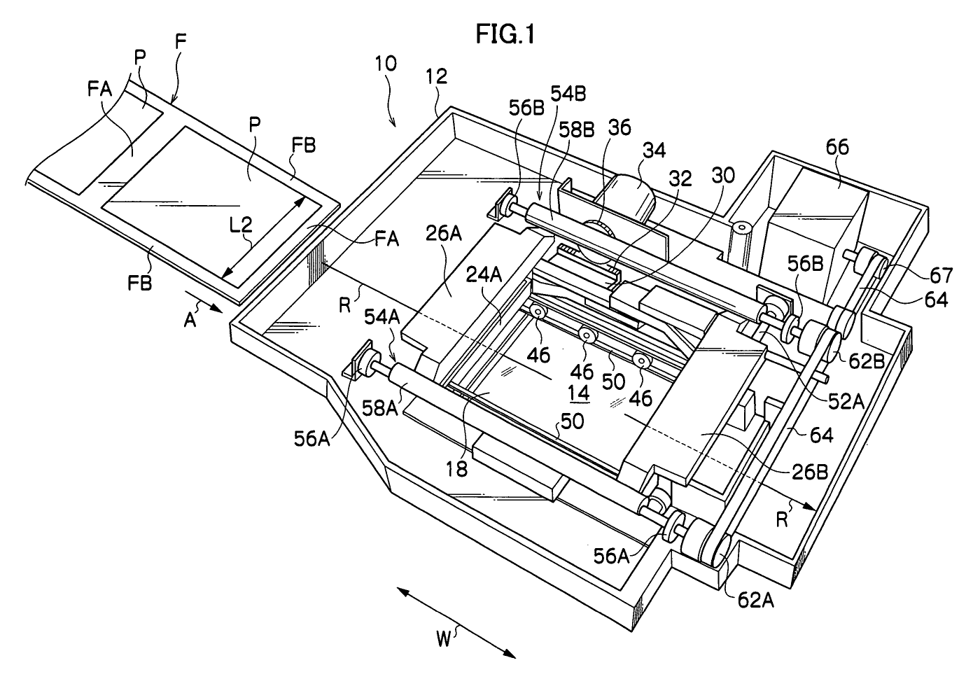

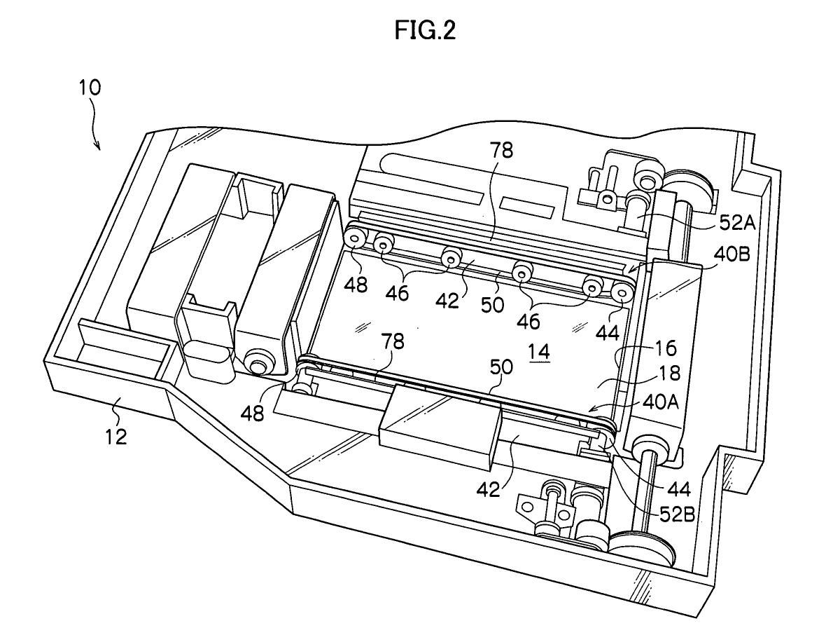

First, a film carrier 10 according to a first embodiment of the invention will be described with reference to FIGS. 1 to 4. The film carrier 10 according to the first embodiment of the invention is a film carrier for medium-format film and configured to be loadable into and unloadable from a scanner. As shown in FIGS. 1 and 2, the film carrier 10 includes a base platform 12 that is attached to the scanner. An image reading section 14 for reading images in the following manner is disposed in the substantial center portion of the base platform 12. That is, an image frame P recorded in photographic film (medium-format film) F is irradiated with light emitted from a light source of the scanner, and the light transmitted through the photographic film F (film-transmitted light) is imaged on a light-receiving surface of an imaging element such as a CCD area sensor by a lens unit of the scanner, whereby the film-transmitted light is converted into an electrical image signal by the imaging element. A film conveyance path R for conveying the photographic film F to the image reading section 14 is formed on the upper surface portion of the base platform 12 such that the film conveyance path R extends along the width direction of the scanner (in the direction of arrow W). The film conveyance path R is schematically illustrated by arrow R in the drawings.

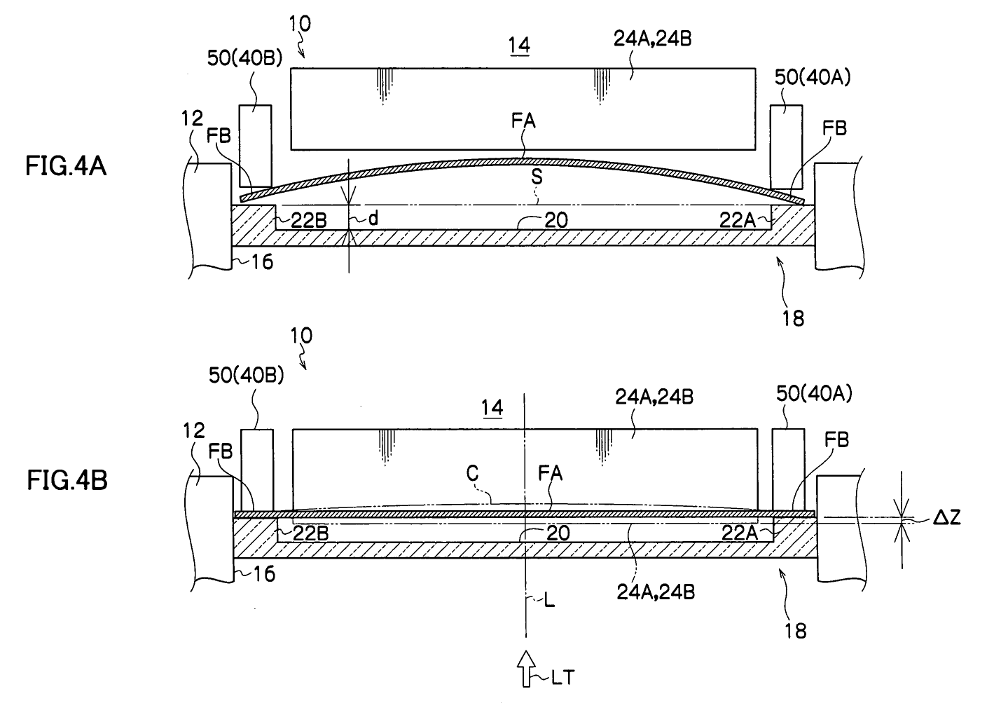

As shown in FIG. 2, a rectangular window portion 16, which is longitudinal in the scanner width direction, is formed in the image reading section 14. A base plate 18, which is contacted by the undersurface of the photographic film F conveyed to the image section 14 and sets the photographic film F at a reference position along the light irradiation direction (see light axis L in FIG. 4B), is fitted in the window portion 16.

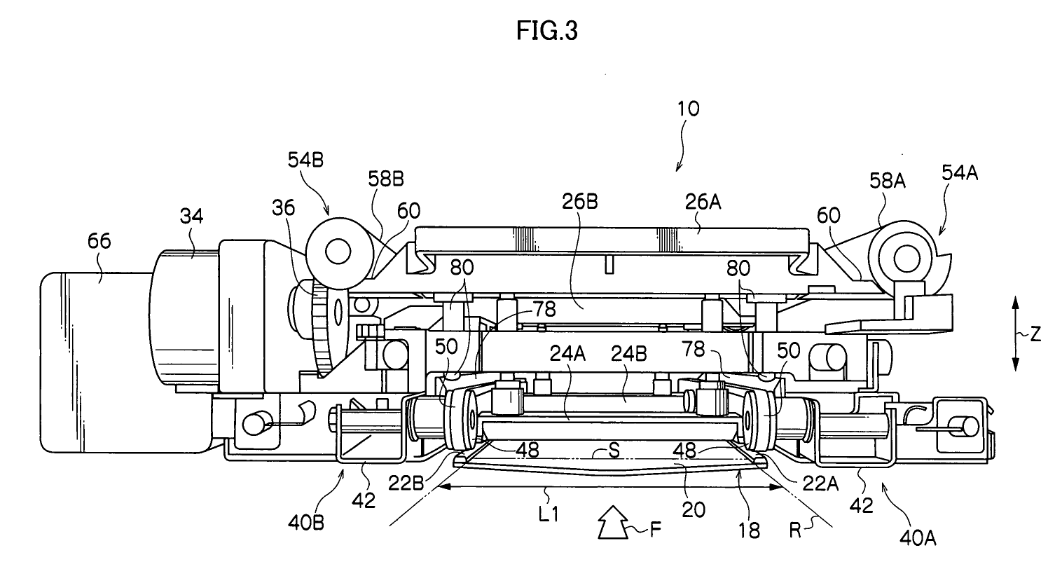

The base plate 18 is formed by a transparent glass plate. As shown in FIG. 3, a concave portion 20 is disposed in the upper surface of the base plate 18 such that the concave portion 20 extends along the film conveyance direction (the direction of arrow A) at a site corresponding to the image frames P of the photographic film F. A pair of convex portions 22A and 22B that form the concave portion 20 is also disposed on the upper surface of the base plate 18 such that the convex portions 22A and 22B extend along both side edge portions of the base plate 18 in the direction orthogonal to the film conveyance direction (i.e., the film width direction). The reference position along the light irradiation direction is configured by the upper surfaces of the pair of convex portions 22A and 22B (image reading reference plane S). A groove width dimension L1 of the concave portion 20 in the direction orthogonal to the film conveyance direction is configured to be slightly larger than a width dimension L2 of the image frames P.

Two masks 24A and 24B that extend along the direction orthogonal to the film conveyance direction are disposed upstream and downstream of the image reading section 14 in the film conveyance path R. The length dimension of the pair of masks 24A and 24B in the direction orthogonal to the film conveyance direction is configured to be slightly smaller than the groove width dimension of the concave portion 20 of the base plate 18 (see FIG. 3). The masks 24A and 24B are attached to and retained by mask retention members 26A and 26B. The mask retention members 26A and 26B are configured such that they can be raised and lowered on the base platform 12 by unillustrated support mechanisms and movable along the film conveyance direction, and are supported such that they can move toward and away from each other (in the directions of arrow W).

Thus, the masks 24A and 24B move toward and away from the base plate 18 (in the directions of arrow Z in FIG. 3) in accompaniment with the raising and lowering of the mask retention members 26A and 26B. The masks 24A and 24B are also disposed such that they are separated by a predetermined distance from the base plate 18 when the mask retention members 26A and 26B are raised, and configured such that they are stopped at a predetermined position substantially coinciding with the image reading reference plane S when the mask retention members 26A and 26B are lowered to a predetermined position.

As shown in FIG. 1, a rack 30 that extends along the film conveyance direction is coupled to one end portion of each of the mask retention members 26A and 26B, and a drive gear 36 of a mask moving motor 34 comprising a stepping motor meshes with a rack gear 32 of the rack 30. Thus, when the mask moving motor 34 causes the drive gear 36 to rotate, the rack 30 moves along the film conveyance direction, and in accompaniment with the movement of the rack 30, the mask retention members 26A and 26B move toward and away from each other while moving in the film conveyance direction and change the mask position resulting from the masks 24A and 24B. Due to the displacement of the masks 24A and 24B, changes in the image frame size in the conveyance direction of the photographic film F can be accommodated.

A pair of pressure units 40A and 40B is disposed at both sides of the image reading section 14 in the direction orthogonal to the film conveyance direction. The pair of pressure units 40A and 40B includes pressure bases 42 that extend along the film conveyance direction. The pressure bases 42 are supported on the base platform 12 by unillustrated support mechanisms such that the pressure bases 42 can be raised and lowered, and are configured to move toward and away from the base plate 18 (the directions of arrow Z in FIG. 3) in accompaniment with the raising and lowering of the mask retention members 26A and 26B.

As shown in FIG. 2, a drive roller 44, four idler rollers 46, and a driven roller 48, which are all arranged along the film conveyance direction, are rotatably disposed on the inner side surface of each of the pressure bases 42. Endless belts 50 are wound onto the drive rollers 44, the idler rollers 46, and the driven rollers 48. The belts 50 extend along the film conveyance direction and, as shown in FIG. 3, are disposed facing the convex portions 22A and 22B disposed on the upper surface of the base plate 18. The belts 50 are disposed such that they are separated a predetermined distance from the convex portions 22A and 22B when the mask retention members 26A and 26B are raised, and press the convex portions 22A and 22B after the masks 24A and 24B stop at their predetermined position when the mask retention members 26A and 26B are lowered to their predetermined position.

As shown in FIG. 2, rotating drive shafts 52A and 52B are coupled to the drive rollers 44 of the pressure units 40A and 40B. The belts 50 of the pressure units 40A and 40B are rotatingly driven by the drive rollers 44 and synchronously rotate and move in a predetermined direction as a result of the rotating drive shafts 52A and 52B being synchronously rotatingly driven by unillustrated belt drive motors.

As shown in FIG. 1, a pair of eccentric cams 54A and 54B is disposed at the outer sides of the pressure units 40A and 40B in the direction orthogonal to the film conveyance direction. Both end portions of each of the pair of eccentric cams 54A and 54B are rotatably supported on a pair of shaft receiving portions 56A and 56B. As shown in FIG. 3, cam portions 58A and 58B contact press surface portions 60 formed on both side portions of the upper surfaces of the mask retention members 26A and 26B.

Timing rollers 62A and 62B are respectively attached to one end portion of each of the eccentric cams 54A and 54B. One endless timing belt 64 is wound between the timing rollers 62A and 62B and a drive roller 67 of a pressure motor 66 comprising a stepping motor. Thus, when the pressure motor 66 is activated and causes the drive roller 67 to rotate, the rotational drive force is transmitted to the timing rollers 62A and 62B via the timing belt 64, and the eccentric cams 54A and 54B synchronously rotate and cause cam surfaces of the cam portions 58A and 58B to move up and down. When the press surface portions 60 are pressed by the cam portions 58A and 58B of the eccentric cams 54A and 54B, the mask retention members 26A and 26B are lowered and move toward the base plate 18. When the pressing by the cam portions 58A and 58B is released, the mask retention members 26A and 26B rise and move away from the base plate 18 due to the spring force of unillustrated spring members disposed in the support mechanisms.

Next, the operation and action by which the film carrier 10 of the present embodiment configured as described above reads images from the image frames P recorded in the photographic film F will be described.

In the film carrier 10 of the present embodiment, the photographic film F is conveyed, by the rotational movement of the belts 50 of the pressure units 40A and 40B, along the film conveyance path R disposed on the upper surface portion of the base platform 12. As shown in FIG. 4A, when the photographic film F is stopped in the image reading section 14, the pressure motor 66 is driven and the mask retention members 26A and 26B are lowered.

In accompaniment with the lowering of the mask retention members 26A and 26B, both conveyance-direction edge portions FA of the film surface are pressed by the pair of masks 24A and 24B, which are moved in the direction toward the base plate 18, and pushed to the image reading reference plane S. Moreover, after the photographic film F is pressed by the masks 24A and 24B, the belts 50 of the pair of pressure units 40A and 40B, which are moved in the direction toward the base plate 18, press both width-direction edge portions FB of the film surface in accompaniment with the lowering of the mask retention members 26A and 26B. As shown in FIG. 4B, both edge portions FB of the photographic film F are nipped between the belts 50 and the convex portions 22A and 22B of the base plate 18 such that the photographic film F is set in the image reading section 14.

In this state, an image frame P recorded in the photographic film F is irradiated with light (indicated by arrow LT in FIG. 4B) emitted from the light source of the scanner and transmitted through the base plate 18, and the light transmitted through the image frame P (transmitted light) is imaged on the light-receiving surface of the imaging element by the lens unit of the scanner. Thus, the film-transmitted light is converted to an electrical signal by the imaging element and read as an image.

Here, the gutter-shaped curl that arises in the photographic film F and has a curvature in the film width direction is significantly reduced as a result of both conveyance-direction edge portions FA of the photographic film F being pressed by the masks 24A and 24B before both width-direction edge portions FB of the photographic film F are nipped between the belts 50 of the pressure units 40A and 40B and the convex portions 22A and 22B of the base plate 18. Consequently, a large curl can be reliably suppressed, and the flatness of the photographic film F can be improved.

Also, in a state where the masks 24A and 24B have been moved away from the base plate 18 and no longer press the photographic film F, the masks 24A and 24B are moved toward and away from each other along the film conveyance direction and disposed at the predetermined mask position in accordance with the size of the image frame P by the relative movement of the mask retention members 26A and 26B by the driving of the mask moving motor 34. Due to the displacement of the masks 24A and 24B, changes in the image frame size in the conveyance direction can be accommodated without damaging the photographic film F.

Sometimes, with respect to photographic film in which there is a large gutter-shaped curl, a curl exceeding an allowable range remains in the center portion of the photographic film F when the pair of masks 24A and 24B that press both conveyance-direction edge portions FA are simply moved to the reference position (image reading reference plane S) along the light irradiation direction, for example. And, if both conveyance-direction edge portions FA end up being pressed onto the base plate 18 as a result of being pressed by the pair of masks 24A and 24B, there is the problem that an air bubble is formed between the photographic film F and the base plate 18 and it becomes difficult for the curl to be collapsed.

However, in the present embodiment, the concave portion 20 is disposed along the film conveyance direction at the site in the base plate 18 corresponding to the image frame P, and as indicated by the two-dotted chain line in FIG. 4B, the masks 24A and 24B are moved until they enter [symbol] Z the inside of the concave portion 20 of the base plate 18 and press both conveyance-direction edge portions FA of the photographic film F, whereby both edge portions FA are pressed beyond the reference position along the light irradiation direction such that the curl C remaining in the center portion of the photographic film F can be reduced to an allowable range. Also, by stopping, at a position where the masks 24A and 24B do not contact the concave portion 20, the masks 24A and 24B that have entered the inside of the concave portion 20, both conveyance-direction edge portions FA of the photographic film F press the base plate 18, an air bubble is not formed between the photographic film F and the base plate 18, and the difficulty of collapsing the curl C can be prevented.

Also, in the present embodiment, because the photographic film F conveyed to the image reading section 14 along the film conveyance path R is conveyed by the belts 50 disposed in the pressure units 40A and 40B such that the belts 50 are rotatingly movable along the conveyance direction, even short photographic film that has been cut up into single frames or several frames can be automatically conveyed.

In the preceding embodiment, the film carrier 10 was configured such that the mask position was changed by causing the masks 24A and 24B to move toward and away from each other, but the film carrier 10 may also be configured such that the mask position is changed by causing one of the masks 24A and 24B to move toward and away from the other of the masks 24A and 24B.

### SECOND EMBODIMENT

Next, a film carrier 10 of a second embodiment of the invention will be described. Portions in the present embodiment corresponding to those in the first embodiment will be identified by identical reference numerals in the same drawings. In the film carrier 10 of the second embodiment, in a state where the masks 24A and 24B have been moved away from the base plate 18 and no longer press the photographic film F, the masks 24A and 24B are moved toward and away from each other along the film conveyance direction and disposed at the predetermined mask position in accordance with the size of the image frame P by the relative movement of the mask retention members 26A and 26B by the driving of the mask moving motor 34. Due to the displacement of the masks 24A and 24B, changes in the image frame size in the conveyance direction can be accommodated without damaging the photographic film F.

Also, due to the rotational movement of the belts 50 of the pressure units 40A and 40B, the photographic film F is conveyed along the film conveyance path R disposed on the upper surface portion of the base platform 12, and when the photographic film F is stopped in the image reading section 14 as shown in FIG. SA, the pressure motor 66 is driven and the mask retention members 26A and 26B are lowered.

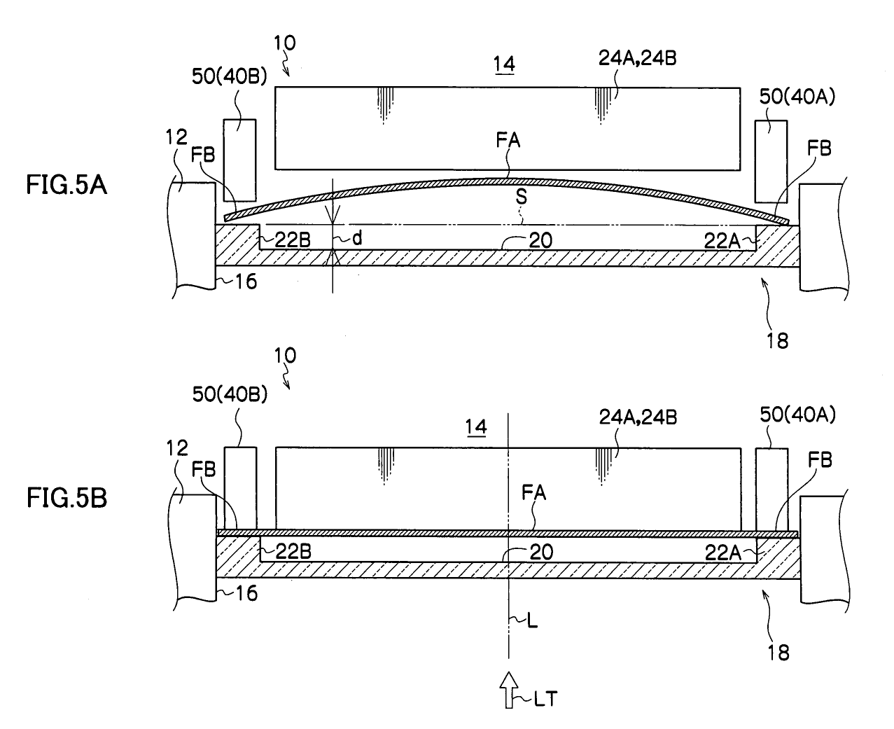

In accompaniment with the lowering of the mask retention members 26A and 26B, both conveyance-direction edge portions FA of the film surface are pressed by the pair of masks 24A and 24B that are moved in the direction toward the base plate 18 (see FIG. 1). Moreover, after the photographic film F is pressed by the masks 24A and 24B, the belts 50 of the pair of pressure units 40A and 40B, which are moved toward the base plate 18, press both width-direction edge portions FB of the film surface in accompaniment with the lowering of the mask retention members 26A and 26B. As shown in FIG. 5B, both edge portions FB of the photographic film F are nipped between the belts 50 and the convex portions 22A and 22B of the base plate 18 such that the photographic film F is set in the image reading section 14.

In this state, an image frame P recorded in the photographic film F is irradiated with light (indicated by arrow LT in FIG. 5B) emitted from the light source of the scanner and transmitted through the base plate 18, and the light transmitted through the image frame P (transmitted light) is imaged on the light-receiving surface of the imaging element by the lens unit of the scanner. Thus, the film-transmitted light is converted to an electrical signal by the imaging element and read as an image.

In photographic film F where the non-image portion at the film edge is about 2 mm as in medium-format film (2B), the open area of the window portion 16 disposed in the image reading section 14 of the film carrier 10 becomes larger, and when the photographic film F is conveyed to the window portion 16, sometimes the leading edge portion of the film falls into the window portion 16 and feeding trouble arises.

Thus, by disposing in the window portion 16 the base plate 18 comprising a glass plate, as in the present embodiment, the leading edge portion of the film can be prevented from falling into the window portion 16. However, if all the four sides surrounding the image frame are pressed in at the time when the photographic film F is pressed, air becomes sealed between the image frame P and the base plate 18. Particularly in a low humidity environment, the curl in the film becomes several mm even after the photographic film F is pressed, and the entire image frame cannot be brought into focus.

In the film carrier 10 of the present embodiment, the gutter-shaped curl that arises in the photographic film F and has a curvature in the film width direction is significantly reduced as a result of both conveyance-direction edge portions FA of the photographic film F being pressed by the masks 24A and 24B before both width-direction edge portions FB of the photographic film F are nipped between the belts 50 of the pressure units 40A and 40B and the convex portions 22A and 22B of the base plate 18. At this time, the air in the space formed between the photographic film F and the base plate 18 escapes to the outside through the concave portion 20 disposed in the upper surface of the base plate 18. Consequently, the curl can be reliably suppressed even in medium-format photographic film F whose film wide size is large as in the present embodiment, the flatness of the photographic film F can be improved, and the entire image frame can be brought into focus.

Also, in the present embodiment, because the photographic film F conveyed to the image reading section 14 along the film conveyance path R is conveyed by the belts 50 disposed in the pressure units 40A and 40B such that the belts 50 are rotatingly movable along the conveyance direction, even short photographic film that has been cut up into single frames or several frames can be automatically conveyed.

Also, in the present embodiment, because the light LT emitted toward the image frame P of the photographic film F is transmitted through the concave portion 20 of the base plate 18 and the entire region of the image frame P is evenly irradiated with a uniform amount of light when the image is read, the image reading is not hindered by the concave portion 20. Also, the open area can be easily enlarged by increasing the depth of the concave portion 20. Thus, the opening portion of a larger open area can be more easily formed in comparison to a configuration where slit-like opening portions are formed in the regions of the base plate 18 outside the image frame P (sites corresponding to both width-direction edge portions FB of the photographic film F). Thus, the ability of the air to be discharged through the concave portion 20 from between the photographic film F and the base plate 18 can be improved.

In the case of medium-format film, it suffices for the step (depth) of the concave portion 20 disposed in the base plate 18 to be 0.2 mm or more (dimension d in FIG. 5A), and because the width dimension of the image frames is about 56 mm with respect to a film width of 60 mm, the air can escape if there is an open area of about 10 mm² in the opening at one side, or about 20 mm² when the openings at both sides are combined. Also, in order to maintain the open area and allow the air to escape, the masks 24A and 24B that press the sides between the image frames are stopped at a position (the focal plane/image reading reference plane S) where the aforementioned height difference remains without the above described fully pressing of the photographic film 20 to the bottom surface of the concave portion 20.

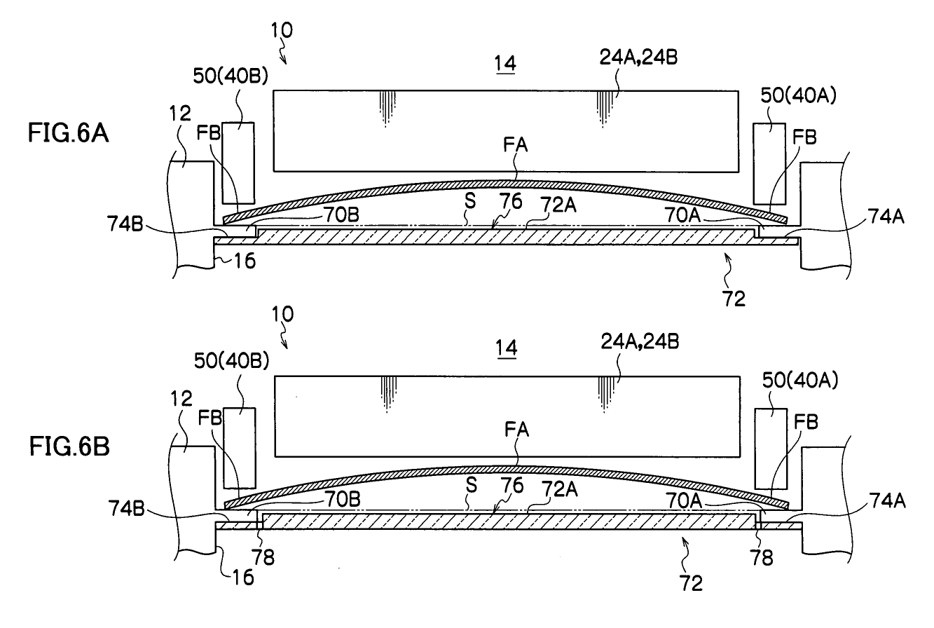

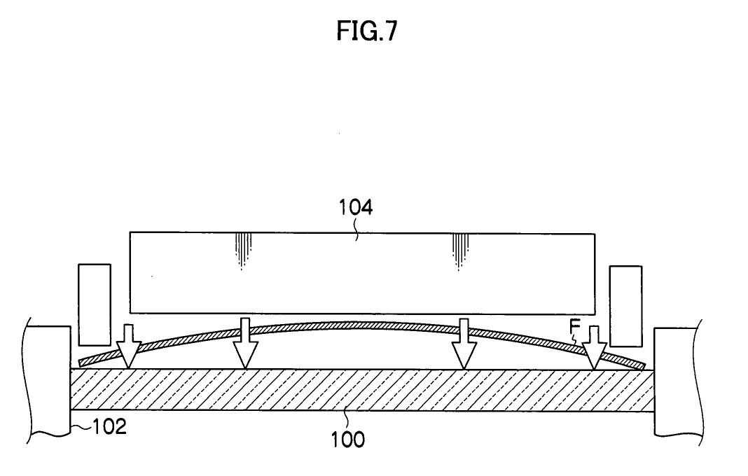

FIGS. 6A and 6B show two modifications of the base plate disposed in the image reading section 14 of the film carrier 10.

In the modification shown in FIG. 6A, a pair of base plate attachment portions 70A and 70B that protrude inward is disposed on both film width-direction inner wall surfaces of the window portion 16. The base plate attachment portions 70A and 70B extend along the film conveyance direction, and the aforementioned image reading reference plane S is configured by the upper surfaces of the base plate attachment portions 70A and 70B.

A base plate 72 includes an upper surface 72A and a pair of stepped portions 74A and 74B that are lower than the upper surface 72A and formed at both film width-direction edge portions of the upper surface 72A. The stepped portions 74A and 74B are fitted together with the undersurfaces of the base plate attachment portions 70A and 70B, whereby the base plate 72 is attached to the window portion 16. Also, the upper surface 72A of the base plate 72 attached to the window portion 16 is lower than the image reading reference plane S, such that a concave portion 76 is formed at the upper surface portion of the base plate 72 by the pair of base plate attachment portions 70A and 70B and the upper surface 72A of the base plate 72. In this modification, a reference plate for setting the photographic film F in the image reading reference plane S is configured by the base plate 72 and the pair of base plate attachment portions 70A and 70B.

Consequently, in the modification shown in FIG. 6A, when the photographic film F conveyed to the image reading section 14 is to be pressed by the masks 24A and 24B and the belts 50 of the pressure units 40A and 40B to reduce the curl, the air in the space formed between the photographic film F and the base plate 72 escapes to the outside through the concave portion 76 disposed in the upper surface portion of the base plate 72, and the flatness of the photographic film F can be improved.

The other modification shown in FIG. 6B is one where, in the configuration of the preceding modification, narrow slits 78 are formed in the base end portions of the stepped portions 74A and 74B of the base plate 72 along the film conveyance direction at positions that do not coincide with the image frames of the photographic film F.

In this configuration, when the photographic film F conveyed to the image reading section 14 is to be pressed to reduce the curl, the air in the space formed between the photographic film and the base plate 72 escapes to the outside through the slits 78 and the concave portion 76 disposed at the upper surface portion of the base plate 72, and the flatness of the photographic film F can be improved.

Also, if the base plate is one where opening portions comprising through holes like the slits 78 are formed therein, it is also possible to dispose the upper surface of the base plate in the same plane as the image reading reference plane S without disposing a concave portion at the upper surface portion of the base plate.

In the preceding description, the film carrier 10 was configured such that the belts 50 of the pressure units 40A and 40B pressed the photographic film F after the photographic film F has been pressed by the masks 24A and 24B; however, the film carrier 10 may also be configured such that the pressing of the photographic film F by the masks 24B and 24B and the pressing of the photographic film F by the belts 50 of the pressure units 40A and 40B are carried out at the same time.

Also, the film carrier 10 may be configured such that the pressure units 40A and 40B do not move up and down, but so that the belts 50 are positioned such that a predetermined clearance equal to or smaller than the thickness of the photographic film F is disposed between the belts 50 and the convex portions 22A and 22B of the base plate 18, so that the photographic film F is conveyed to the image reading section 14 as a result of the belts 50 pressingly contacting both width-direction edge portions FB of the photographic film F and being rotatingly driven.

In this case, both conveyance-direction edge portions FA of the photographic film F conveyed to the image reading section 14 are pressed by the pair of masks 24A and 24B in a state where both width-direction edge portions FB of the photographic film F are nipped between the belts 50 of the pressure units 40A and 40B and the convex portions 22A and 22B of the base plate 18. Even with this operation, the air in the space formed between the photographic film F and the base plate 18 escapes to the outside through the concave portion 20 in accompaniment with the gutter-shaped curl in the photographic film F being collapsed by the masks 24A and 24B. Thus, the curl can be reliably suppressed and the flatness of the photographic film F can be improved.

### THIRD EMBODIMENT

Next, a film carrier 10 of a third embodiment of the invention will be described. Portions in the present embodiment corresponding to those in the first and second embodiments will be identified by identical reference numerals in the same drawings. As shown in FIG. 3, in the film carrier 10 of the third embodiment, a pair of push pins 80 that protrude downward is disposed in the vicinity of both film width-direction side end portions on the undersurface portions of the mask retention members 26A and 26B.

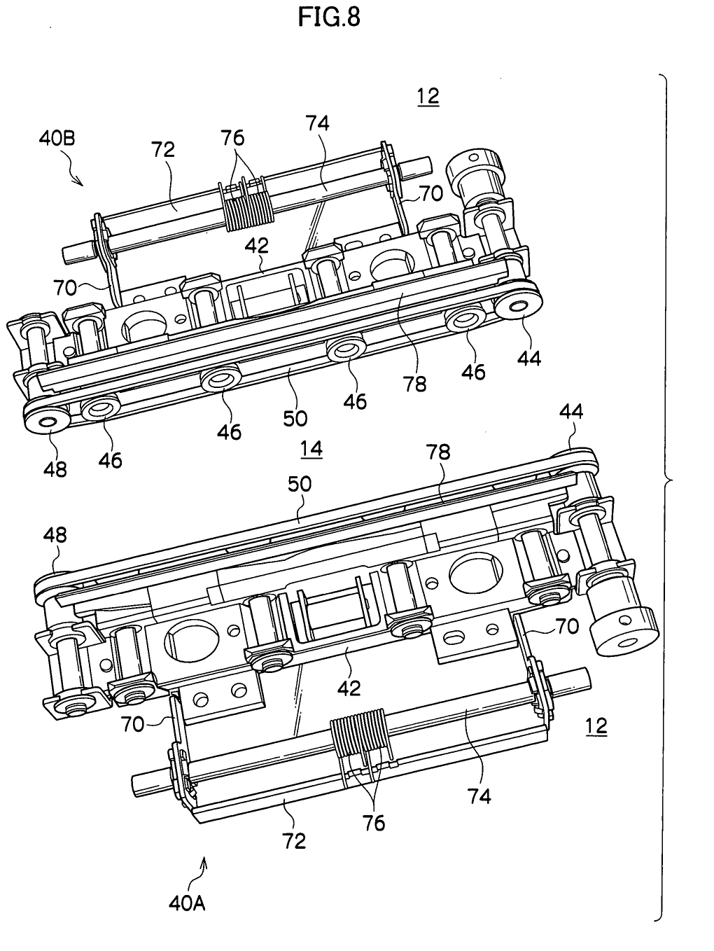

Also, instead of the pressure units 40A and 40B in the first embodiment, a pair of conveyance units 40A and 40B is disposed at both sides of the image reading section 14 in the direction orthogonal to the film conveyance direction. As shown in FIG. 8, the pair of conveyance units 40A and 40B includes unit bases 42 that extend along the film conveyance direction. A pair of arm portions 70 that extend outward along the direction orthogonal to the film conveyance direction is disposed on the outer side surfaces of the unit bases 42, and the leading end portions of the pair of arm portions 70 are coupled together by coupler plate portions 72. The leading end sides of the pair of arm portions 70 are rotatably axially supported on support shafts 74 that are attached to unillustrated support portions of the base platform 12, such that the conveyance units 40A and 40B rotate around the support shafts 74 and can be raised and lowered.

Two torsion coil springs 76 are passed around and attached to the center portions of the support shafts 74. The spring force of the torsion coil springs 76 acts on the coupler plate portions 72 of the arm portions 70, such that the conveyance units 40A and 40B pivot around the support shafts 74 and are urged toward the base plate 18 (downward). The undersurfaces of the unit bases 42 contact unillustrated adjustment screws that protrude from the base platform 12 so that the interval between the base plate 18 and the conveyance units 40A and 40B is maintained constant, and the interval between the base plate 18 and the conveyance units 40A and 40B can be adjusted by rotating the adjustment screws.

As shown in FIG. 2, a drive roller 44, four idler rollers 46, and a driven roller 48, which are all arranged along the film conveyance direction, are rotatably disposed on the inner side surface of each of the unit bases 42. Endless belts 50 are wound onto the drive rollers 44, the idler rollers 46, and the driven rollers 48. The belts 50 extend along the film conveyance direction. As shown in FIG. 3, the belts 50 are disposed facing the convex portions 22A and 22B disposed on the upper surface of the base plate 18. The interval (clearance) between the undersurfaces of the belts 50 and the convex portions 22A and 22B is adjusted by the adjustment screws to become a predetermined interval.

As shown in FIG. 8, inclined surface portions 78, which are positioned above the belts 50 and extend substantially parallel to the belts 50, are disposed on the upper portions of the unit bases 42. As shown in FIG. 3, the inclined surface portions 78 are positioned below the pair of push pins 80 disposed on the undersurface portions of the mask retention members 26A and 26B.

Also, the conveyance units 40A and 40B are configured such that when the mask retention members 26A and 26B are lowered, the inclined surface portions 78 are pushed by the leading end portions of the push pins 80, whereby the belts 50 are moved in directions which widen the interval between the belts 50, and when the mask retention members 26A and 26B are raised from this state and the inclined surface portions 78 are no longer pushed by the pair of push pins 80, the belts 50 are moved inward such that the interval between the belts 50 is restored to the original interval. Moreover, the moving operation by which the interval between the belts 50 is widened is conducted after the masks 24A and 24B have been lowered in accompaniment with the lowering of the mask retention members 26A and 26B and stopped at the predetermined position.

As shown in FIG. 2, rotating drive shafts 52A and 52B are coupled to the drive rollers 44 of the conveyance units 40A and 40B. The belts 50 of the conveyance units 40A and 40B are rotatingly driven by the drive rollers 44 and synchronously rotate and move in a predetermined direction as a result of the rotating drive shafts 52A and 52B being synchronously rotatingly driven by unillustrated belt drive motors.

As shown in FIG. 1, a pair of eccentric cams 54A and 54B is disposed at the outer sides of the conveyance units 40A and 40B in the direction orthogonal to the film conveyance direction. Both end portions of each of the eccentric cams 54A and 54B are rotatably supported on a pair of shaft receiving portions 56A and 56B. As shown in FIG. 3, cam portions 58A and 58B contact press surface portions 60 formed on both side portions of the upper surfaces of the mask retention members 26A and 26B.

Timing rollers 62A and 62B are respectively attached to one end portion of each of the eccentric cams 54A and 54B. One endless timing belt 64 is wound between the timing rollers 62A and 62B and a drive roller 67 of a pressure motor 66 comprising a stepping motor. Thus, when the pressure motor 66 is activated and causes the drive roller 67 to rotate, the rotational drive force is transmitted to the timing rollers 62A and 62B via the timing belt 64, and the eccentric cams 54A and 54B synchronously rotate and cause cam surfaces of the cam portions 58A and 58B to move up and down. When the press surface portions 60 are pressed by the cam portions 58A and 58B of the eccentric cams 54A and 54B, the mask retention members 26A and 26B are lowered and move toward the base plate 18. When the pressing by the cam portions 58A and 56B is released, the mask retention members 26A and 26B rise and move away from the base plate 18 due to the spring force of unillustrated spring members disposed in the support mechanisms.

Next, the operation and action by which the film carrier 10 of the present embodiment configured as described above reads images from the image frames P recorded in the photographic film F will be described.

In the film carrier 10 of the present embodiment, in a state where the masks 24A and 24B have been moved away from the base plate 18 and no longer press the photographic film F, the masks 24A and 24B are moved toward and away from each other along the film conveyance direction and are disposed at the predetermined mask position in accordance with the size of the image frame P by the relative movement of the mask retention members 26A and 26B by the driving of the mask moving motor 34. By displacement of the masks 24A and 24B, changes in the image frame size in the conveyance direction can be accommodated without damaging the photographic film F.

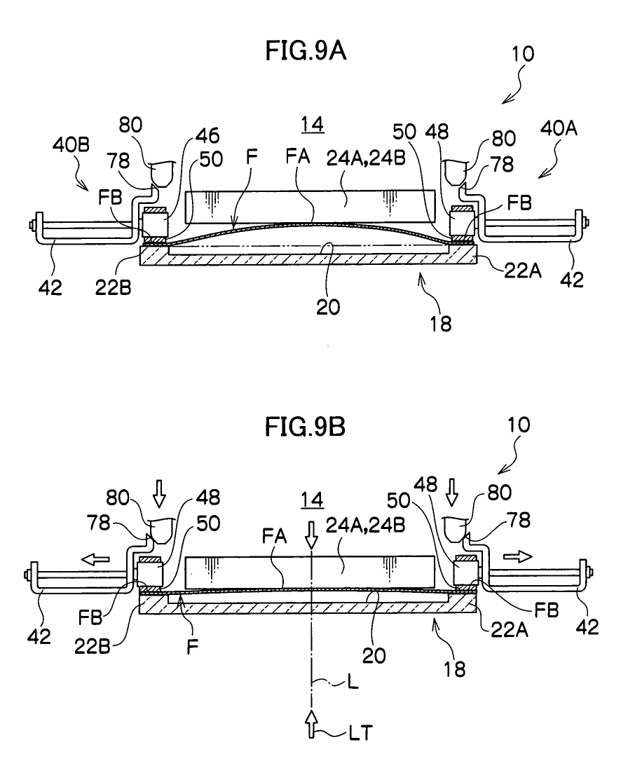

Also, the belts 50 of the conveyance units 40A and 40B disposed at a predetermined interval with respect to the convex portions 22A and 22B of the base plate 18 rotatingly move in a state where they pressingly contact both width-direction edge portions FB of the surface of the photographic film F, whereby the photographic film F is conveyed along the film conveyance path R disposed on the upper surface portion of the base platform 12. As shown in FIG. 9A, when the photographic film F is stopped in the image reading section 14, the pressure motor 66 is driven and the mask retention members 26A and 26B are lowered.

In accompaniment with the lowering of the mask retention members 26A and 26B, both conveyance-direction edge portions FA of the film surface of the photographic film F are pressed by the pair of masks 24A and 24B that are moved in the direction toward the base plate 18 (see FIG. 1). Also, the belts 50 of the conveyance units 40A and 40B pressingly contact both width-direction edge portions FB of the film surface and are widened in the width direction in accompaniment with the lowering of the mask retention members 26A and 26B, whereby the photographic film F is set in the image reading section 14 in a state where both edge portions FB are nipped between the belts 50 and the convex portions 22A and 22B of the base plate 18, as shown in FIG. 9B.

In this state, an image frame P recorded in the photographic film F is irradiated with light (indicated by arrow LT in FIG. 9B) emitted from the light source of the scanner and transmitted through the base plate 18, and the light transmitted through the image frame P (transmitted light) is imaged on the light-receiving surface of the imaging element by the lens unit of the scanner. Thus, the film-transmitted light is converted to an electrical signal by the imaging element and read as an image.

Here, the gutter-shaped curl that arises in the photographic film F and has a curvature in the film width direction is reduced as a result of both film conveyance-direction edge portions FA of the photographic film F being pressed by the masks 24A and 24B, and is pulled in the width direction and further reduced as a result of the belts 50 of the conveyance units 40A and 40B pressingly contacting both width-direction edge portions FB of the photographic film F being widened in the width direction. Consequently, a large curl can be reliably suppressed, and the flatness of the photographic film F can be improved.

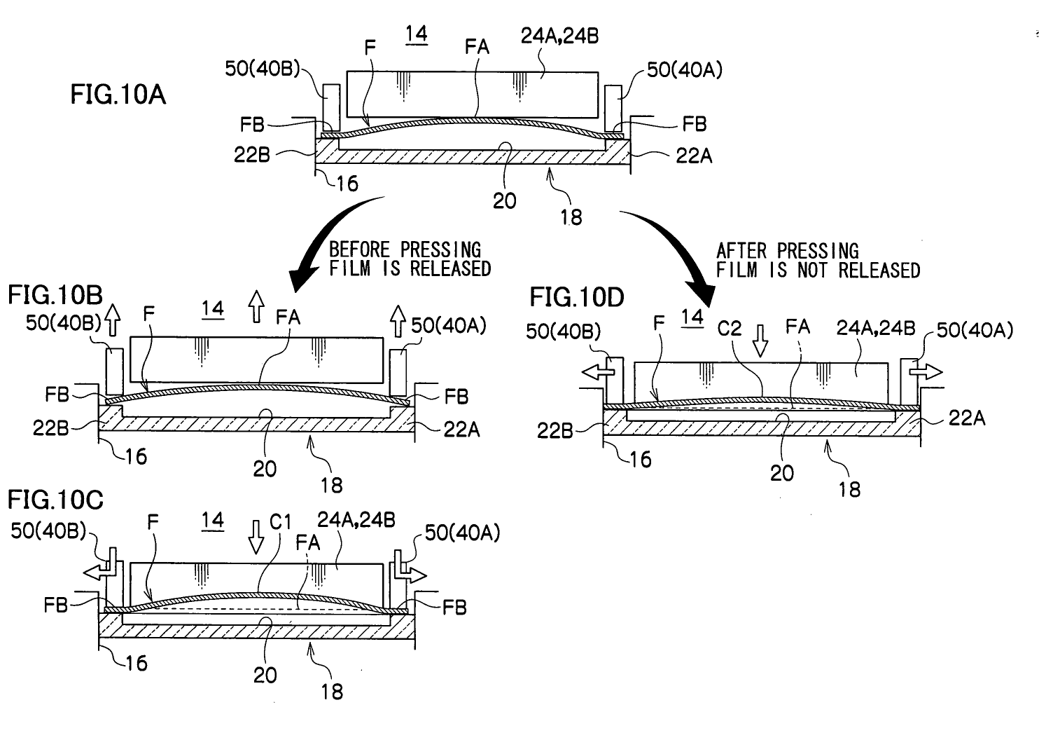

FIGS. 10A to 10D show examples where, with respect to the photographic film F set in the image reading section 14 of the film carrier 10 of the present embodiment, the size of the curl remaining in the photographic film F is compared between a case where the masks 24A and 24B and the conveyance units 40A and 40B are temporarily raised to release the photographic film F and then press the photographic film F, and a case where, as in the preceding operation, the masks 24A and 24B and the conveyance units 40A and 40B are not raised, that is, where the photographic film F is not released but pressed from the state where it is suppressed in advance.

As shown in FIG. 10B, when the masks 24A and 24B and the conveyance units 40A and 40B are temporarily raised to release the photographic film F that has set in the image reading section 14 as shown in FIG. 10A, the curl in the photographic film F reverts back to normal when the curl is large. For this reason, as shown in FIG. 1C, even if the photographic film F is pressed by the masks 24A and 24B and is pulled in the width direction by the belts 50 of the conveyance units 40A and 40B to press the curl down, the center portion of the image frame becomes large with respect to the portion surrounding the image frame, and a large raised curl C1 remains.

In contrast, when the photographic film F is pressed by the masks 24A and 24B and pulled in the width direction by the belts 50 of the conveyance units 40A and 40B without raising the masks 24A and 24B and the conveyance units 40A and 40B from the suppressed state resulting from the masks 24A and 24B and the conveyance units 40A and 40B where the photographic film F has been set in the image reading section 14, the curl can be more greatly reduced (curl C1>curl C2), as shown in FIG. 10D.

Consequently, the pressing and pulling that are conducted without releasing the photographic film F set in the image reading section 14 as in the present embodiment can improve the flatness of the photographic film F and is effective in comparison to when the photographic film F is temporarily released.

Also, in the present embodiment, the gutter-shaped curl arising in the photographic film F is significantly reduced as a result of both film conveyance-direction edge portions FA being pressed by the masks 24A and 24B before both film width-direction edge portions FB are pulled in the width direction by the belts 50 of the conveyance units 40A and 40B. In this manner, because the belts 50 of the conveyance units 40A and 40B are widened in the width direction and pull the photographic film F in the width direction after the gutter-shaped curl has been significantly reduced, the curl can be more reliably suppressed and the flatness of the photographic film F can be further improved.

Also, in the present embodiment, because the photographic film F conveyed to the image reading section 14 along the film conveyance path R is conveyed by the belts 50 disposed in the conveyance units 40A and 40B such that the belts 50 are rotatingly movable along the conveyance direction, even short photographic film that has been cut up into single frames or several frames can be automatically conveyed. Also, because the outer peripheral surfaces of the belts 50 flatly contact the edge portions FB of the photographic film F when the belts 50 are pressed against the edge portions FB, the belts 50 cause a widening force in the width direction to act substantially equally on the edge portions FB, such that the flatness of the photographic film F can be excellently maintained without the curl partially remaining.

When the film carrier is directed to medium-format film (2B) as in the film carrier 10 of the present embodiment, the non-image portion disposed at the film end of the medium-format film is about 2 mm. Thus, it is preferable for the width of the belts 50 to be 2 mm or less. In the case of a belt conveyance format, it is necessary for the frictional force arising between the belts 50 and the photographic film F to be greater than the frictional force arising between the base plate 18 and the photographic film F in order for the photographic film F to be stably conveyed. Consequently, if the material of the base plate 18 is glass or the like, it is preferable for the material of the belts 50 to be urethane rubber or the like.

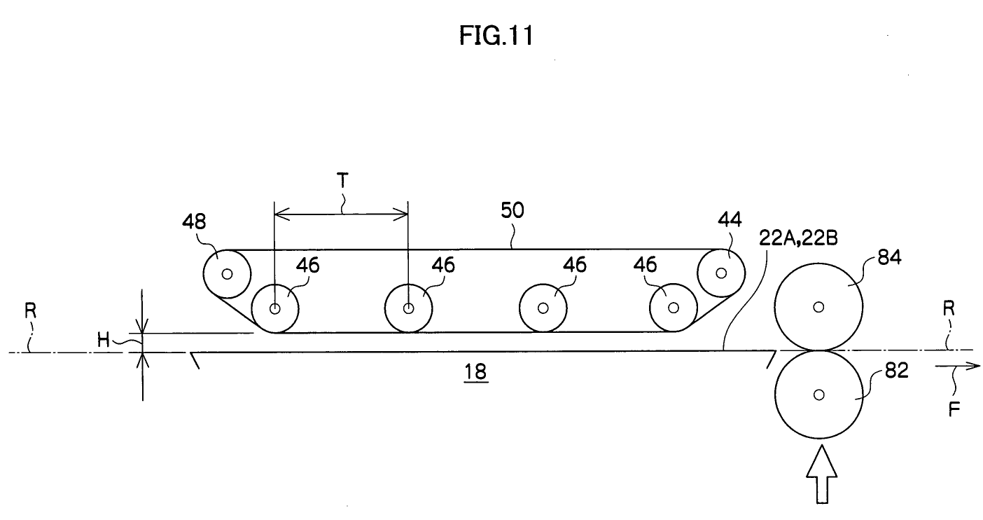

Also, as shown in FIG. 11, it is preferable to dispose, between the belts 50 and the base plate 18 (the convex portions 22A and 22B), a clearance H that is equal to or less than the thickness of the film (e.g., 0.05 to 0.1 mm). Thus, the belts 50 do not rub against the base plate 18 when the belts 50 are not conveying the photographic film F, and deterioration in the durability of the belts 50 and deterioration in the stability of film conveyance resulting from deterioration in the frictional force of the belts 50 can be prevented.

Also, in order for the belts 50 to press the photographic film F, it is preferable for an interval T between adjacent idler rollers 46 plurally arranged along the film conveyance direction (the direction of arrow F) to be equal to or less than the length of the minimum size photographic film that is to be conveyed. Thus, even when minimum size photographic film is to be conveyed, the photographic film is always pressed by the belts 50 via the idler rollers 46, conveyance-direction variations in the pressing force with respect to the photographic film (nipping force between the belts 50 and the base plate 18) are suppressed, and deterioration in the conveyance precision can be prevented.

Also, as shown in FIG. 11, when a conveyance roller pair comprising a drive roller 82 and a driven roller 84 is disposed as film conveyance unit at a portion outside the belt in the film conveyance path R, the material of the rollers is urethane rubber or the like, and at least one of the rollers is made to press against the other with a spring or the like (in the example in FIG. 11, the drive roller 82 is made to press the driven roller 84).

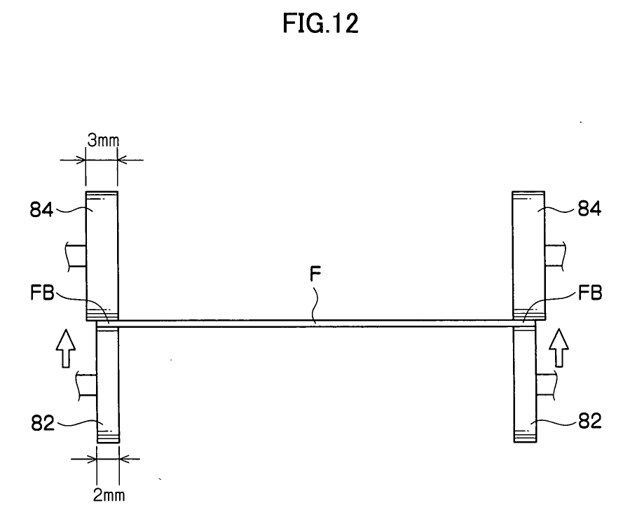

Also, as shown in FIG. 12, similar to the belts 50, it is preferable for the width of the rollers contacting the non-image portion disposed at the film end of the medium-format film to be 2 mm or less. Moreover, in the case of a roller that is made of urethane rubber and has a diameter of 20 mm, it is preferable for the pressing force to be 8 N or less in order for the photographic film F to be stably conveyed by a roller with such a narrow width. It was confirmed through experiment that when the pressing force of the roller exceeds 8 N in the configuration of this example, meandering and speed fluctuations during film conveyance become larger, and the conveyance precision is no longer kept in an allowable range. Also, the conveyance precision becomes better when the rollers are set to respectively different hardnesses. For example, in the case of rollers made of urethane rubber, a combination of JIS A rubber hardness degree stipulated in JIS K6253 of 60-80 with that of 80-100 is preferable, and a combination of 65-75 with 85-95 degrees is more preferable.

In the preceding embodiment, the film carrier 10 was configured such that the belts 50 of the conveyance units 40A and 40B were widened in the width direction after the photographic film F has been pressed by the masks 24A and 24B, but the film carrier 10 may also be configured such that the pressing of the photographic film F by the masks 24A and 24B and the movement of the belts 50 of the conveyance units 40A and 40B in the width direction are carried out at the same time.

What is claimed is:

1. A film carrier that conveys photographic film along a conveyance path to an image reading position, in order to read an image by irradiating with light an image frame recorded in the photographic film, the film carrier comprising:
a reference plate that is disposed at the image reading position, is contacted by the undersurface of the photographic film conveyed to the image reading position, and sets the photographic film at a reference position along the light irradiation direction;
a pair of mask members that are positioned upstream and downstream of the image reading position in the conveyance direction of the photographic film, are configured to move toward and away from the reference plate, with at least one of the pair of mask members being movable along the conveyance direction, and that press and release both conveyance-direction edge portions of the surface of the photographic film conveyed to the image reading position;
mask member moving unit that causes the pair of mask members to move toward and away from the reference plate and causes at least one of the pair of mask members to move along the conveyance direction in accordance with the size of the image frame;
a pair of pressure members that are positioned at both sides of the image reading position in the width direction of the photographic film, are configured to move toward and away from the reference plate, press both width-direction edge portions of the surface of the photographic film conveyed to the image reading position to nip the photographic film between the reference plate and the pair of pressure members, and release the photographic film such that the photographic film is no longer nipped between the pair of pressure members and the reference plate; and
pressure member moving unit that causes the pair of pressure members to move toward and away from the reference plate,
wherein with respect to the photographic film conveyed to the image reading position, the pair of pressure members is caused to press the photographic film after the photographic film is pressed by the pair of mask members.

2. The film carrier of claim 1, wherein the reference plate includes a concave portion along the conveyance direction at a site corresponding to the image frame, and in the pressing of the photographic film by the pair of mask members, the pair of mask members is caused to enter the concave portion and is stopped at a position where the pair of mask members does not contact the concave portion.

3. The film carrier of claim 1, wherein the pressure members include endless belts disposed such that the endless belts are rotatingly movable along the conveyance direction.

4. The film carrier of claim 2, wherein the pressure members include endless belts disposed such that the endless belts are rotatingly movable along the conveyance direction.

5. A film carrier that conveys photographic film along a conveyance path to an image reading position, in order to read an image by irradiating with light an image frame recorded in the photographic film, the film carrier comprising:
a reference plate that is disposed at the image reading position, is contacted by the undersurface of the photographic film conveyed to the image reading position, and sets the photographic film at a reference position along the light irradiation direction;
four press members that are positioned upstream and downstream of the image reading position in the conveyance direction of the photographic film and at both sides of the image reading position in the width direction of the photographic film, are configured to move toward and away from the reference plate, and press and release both conveyance-direction edge portions and both width-direction edge portions of the surface of the photographic film conveyed to the image reading position;
moving unit that causes the four press members to move toward and away from the reference plate; and
an opening portion that is disposed in the reference plate and allows air to escape from a space formed between the photographic film and the reference plate when the photographic film is pressed by the four press members.

6. A film carrier that conveys photographic film along a conveyance path to an image reading position, in order to read an image by irradiating with light an image frame recorded in the photographic film, the film carrier comprising:
a reference plate that is disposed at the image reading position, is contacted by the undersurface of the photographic film conveyed to the image reading position, and sets the photographic film at a reference position along the light irradiation direction;
a pair of press members that are positioned upstream and downstream of the image reading position in the conveyance direction of the photographic film, are configured to move toward and away from the reference plate, and press and release both conveyance-direction edge portions of the surface of the photographic film conveyed to the image reading position;
moving unit that causes the pair of press members to move toward and away from the reference plate;
a pair of conveyance units that are disposed at both sides of the image reading position in the width direction of the photographic film, pressingly contact both width-direction edge portions of the surface of the photographic film, and convey the photographic film to the image reading position; and
an opening portion that is disposed in the reference plate and allows air to escape from a space formed between the photographic film and the reference plate when the photographic film is pressed by the pair of press members.

7. The film carrier of claim 6, wherein the conveyance units include endless belts disposed such that the endless belts are rotatingly movable along the conveyance direction.

8. The film carrier of claim 5, wherein the opening portion is a concave portion disposed along the conveyance direction at a site in the reference plate corresponding to the image frame.

9. The film carrier of claim 6, wherein the opening portion is a concave portion disposed along the conveyance direction at a site in the reference plate corresponding to the image frame.

10. The film carrier of claim 7, wherein the opening portion is a concave portion disposed along the conveyance direction at a site in the reference plate corresponding to the image frame.

11. A film carrier that conveys photographic film along a conveyance path to an image reading position, in order to read an image by irradiating with light an image frame recorded in the photographic film, the film carrier comprising:
a reference plate that is disposed at the image reading position, is contacted by the undersurface of the photographic film conveyed to the image reading position, and sets the photographic film at a reference position along the light irradiation direction;
a pair of press members that are positioned upstream and downstream of the image reading position in the conveyance direction of the photographic film, are configured to move toward and away from the reference plate, and press and release both conveyance-direction edge portions of the surface of the photographic film conveyed to the image reading position;
a pair of conveyance units that are positioned at a predetermined interval with respect to the reference plate at both sides of the image reading position in the width direction of the photographic film, pressingly contact both width-direction edge portions of the surface of the photographic film, and convey the photographic film to the image reading position; and
moving unit(s) that causes the pair of press members to move toward and away from the reference plate and causes the pair of conveyance units to move in the width direction.

12. The film carrier of claim 11, wherein with respect to the photographic film conveyed to the image reading position, the pair of conveyance units is widened in the width direction after the photographic film is pressed by the pair of press members.

13. The film carrier of claim 11, wherein the conveyance units include endless belts disposed such that the endless belts are rotatingly movable along the conveyance direction.

14. The film carrier of claim 12, wherein the conveyance units include endless belts disposed such that the endless belts are rotatingly movable along the conveyance direction.
